(19) United States
(12) Patent Application Publication
(10) Pub. No.: US 2025/0333199 A1
(43) Pub. Date: Oct. 30, 2025

(54) MOBILE MICRO-GRID SYSTEM

(71) Applicant: Michael James LABARBA, Flower Mound, TX (US)

(72) Inventor: Michael James LABARBA, Flower Mound, TX (US)

(21) Appl. No.: 19/195,371

(22) Filed: Apr. 30, 2025

Related U.S. Application Data
(60) Provisional application No. 63/640,688, filed on Apr. 30, 2024.
(60) Provisional application No. 63/663,235, filed on Jun. 24, 2024.

(51) Int. Cl. B64U 50/38; B64F 1/35; B64U 50/31; B64U 70/93

(52) U.S. Cl. CPC B64U 50/38; B64F 1/352; B64U 50/31; B64U 70/93; B64U 2201/10

(57) ABSTRACT

A mobile micro-grid system for supporting unmanned aerial vehicle (UAV) operations includes a containerized housing with at least one door operable between a stored position and a deployed position. Each door is associated with a UAV docking station configured to transfer power to a UAV. A renewable energy subsystem mounted on the container provides power to an onboard energy storage system, which supplies energy to the UAV docking stations. A control system within the container manages charging schedules based on power availability, autonomously deploys UAVs, and maintains communications during landing, takeoff, and charging. A method for managing UAV operations includes receiving flight schedule and energy data, wirelessly charging UAVs, deploying UAVs from a landing platform, and monitoring flight and battery status via a communications link. In another embodiment, a flight control subsystem coordinates UAV launch timing based on energy availability and generates alerts for power shortages affecting UAV readiness.

### CROSS-REFERENCE TO RELATED APPLICATIONS

This application claims the benefit of U.S. Provisional Application Ser. No. 63/640,688, filed Apr. 30, 2024, and entitled “MOBILE MICRO-GRID SYSTEM,” which is hereby incorporated by reference for all purposes.

This application also claims the benefit of U.S. Provisional Application Ser. No. 63/663,235, filed Jun. 24, 2024, and entitled “MOBILE MICRO-GRID SYSTEM,” which is hereby incorporated by reference for all purposes.

### BACKGROUND

Unmanned aerial vehicles (UAVs) are increasingly employed in logistics, infrastructure inspection, environmental monitoring, disaster response, and defense operations. These platforms offer the ability to conduct autonomous or semi-autonomous missions across diverse and remote environments, often beyond the reach of conventional ground-based systems. However, UAV operations remain constrained by limitations in onboard energy capacity, which affects both range and duration. Frequent recharging is required, and mission reliability often depends on the availability of robust, localized infrastructure for energy replenishment and system coordination.

Conventional UAV deployment strategies typically rely on fixed charging stations located within range of existing power grids or tethered to mobile generators. These arrangements can require significant human intervention, including setup, maintenance, and direct handling of UAV hardware. Power availability at remote locations may be limited or intermittent, and integrating renewable energy sources can introduce additional system complexity. Moreover, traditional mobile power systems are not optimized for concurrent energy storage, autonomous UAV control, and integrated communications, leading to inefficiencies and operational delays.

Existing approaches further lack modular scalability and often do not support real-time energy management or coordinated UAV scheduling. While certain mobile platforms provide recharging or refueling functions, they are frequently limited to specific vehicle types or mission profiles. These systems may not support autonomous launch and recovery, or may be unable to operate effectively in off-grid environments without extensive external support. The absence of standardized containerized deployment systems and automated energy-aware scheduling reduces the practicality of large-scale UAV operations in field conditions.

### SUMMARY

The embodiments herein provide for a mobile micro-grid (MMG) system. According to one aspect of the invention, the mobile micro-grid system includes a containerized housing that supports autonomous operation of unmanned aerial vehicles (UAVs) through integrated power generation, storage, and deployment capabilities. A set of doors mounted to the container are operable between a stored position and a deployed position, where each door is associated with at least one UAV docking station configured for power transfer. The renewable energy subsystem includes one or more power sources mounted to the container exterior and is electrically coupled to an onboard energy storage system, which supplies power to the UAV docking stations. A control system within the container manages UAV charging schedules, facilitates UAV deployment through the deployed doors, and maintains communication with UAVs throughout their charging and operational cycles.

Another aspect of the invention provides a method for autonomously managing UAVs using the mobile micro-grid system. The method includes providing a containerized system with a deployable landing platform, renewable energy subsystem, power storage system, and wireless charging infrastructure. The system receives flight schedules and energy availability data, charges UAVs wirelessly in accordance with energy capacity, and autonomously deploys UAVs from the platform. Communications links are used to monitor in-flight UAV status and battery condition, enabling responsive updates and control throughout mission execution.

Yet another aspect of the invention provides for a transportable container with fold-out doors acting as UAV landing pads, a set of docking bays, and an energy subsystem comprising a solar array, battery bank, and inverter. A backup generator is included for additional power support. A flight control subsystem coordinates UAV launch timing based on energy availability and includes software for tracking UAVs, managing charge cycles, and issuing alerts for projected power shortages. The system architecture supports modular deployment and autonomous coordination of UAV resources from a mobile, self-powered infrastructure.

Other aspects of the invention will be apparent from the following description and the appended claims.

### BRIEF DESCRIPTION OF DRAWINGS

FIGS. 1A and 1B are elevation and plan views, respectively, of a mobile micro-grid system in accordance with one or more illustrative embodiments of the invention.

FIG. 2 is a front elevation view of the mobile micro-grid system in a deployed configuration, in accordance with one or more illustrative embodiments of the invention.

FIG. 3 is a perspective view of the mobile micro-grid system showing rotatable solar panels deployed along a lateral side of the container, in accordance with one or more illustrative embodiments of the invention.

FIG. 4 is a top plan view of the containerized system, illustrating internal UAV storage, utility room layout, and docking station arrangements in accordance with one or more illustrative embodiments of the invention.

FIG. 5 is a schematic representation of a UAV docking assignment system using identification codes, in accordance with one or more illustrative embodiments of the invention.

FIGS. 6A and 6B are detailed views of portions of the container, in accordance with one or more illustrative embodiments of the invention.

FIG. 7 is a plan view showing the location of a computing system within the container, in accordance with one or more illustrative embodiments of the invention.

FIGS. 8A and 8B show a computing system in accordance with one or more embodiments of the invention.

Like elements in the various figures are denoted by like reference numerals for consistency.

### DETAILED DESCRIPTION

The embodiments herein provide for a mobile micro-grid (MMG) system that provides a containerized platform for supporting unmanned aerial vehicle (UAV) operations through integrated power generation, energy storage, and autonomous control. Unlike prior mobile generator-based systems or fixed-site recharging infrastructure, the MMG system incorporates a renewable energy subsystem, such as rooftop-mounted solar panels or rotatable photovoltaic arrays, coupled to an onboard energy storage system housed within a standard intermodal container. This enables off-grid power generation and UAV support without reliance on external fuel supplies or fixed electrical infrastructure. A generator subsystem, including embodiments using hydrogen generation, can further supplement stored energy or provide hydrogen gas to fuel cell-powered UAVs.

UAV docking stations are embedded into or associated with actuated container doors that operate between vertical storage and horizontal deployed positions. These doors serve as launch and landing platforms, each integrating wireless charging pads to support contactless energy transfer to UAVs. A storage bay within the container is configured to house UAVs in a 1:1 alignment with the docking stations, reducing deployment time and mechanical complexity. Docking stations may be identified using encoded markers such as QR codes or RFID tags, and the computing system tracks each UAV's assigned location to coordinate charging and launch operations. A utility room within the container houses the load panel, energy storage system (ESS) inverter, and thermal control hardware to manage internal system power and operating conditions.

A computing system located within the container manages UAV charging schedules, launch sequencing, and system-level power allocation using flight plan data, available energy input, and onboard telemetry. The control software can dynamically allocate energy between UAV charging and auxiliary functions, generate alerts based on predicted power shortfalls, and remotely execute system commands over secure communication links. Communications between the MMG system and UAVs are maintained via onboard wireless transmitters during all phases of operation, including takeoff, flight, and landing. These features enable a fully autonomous UAV deployment and energy management capability packaged within a mobile and scalable infrastructure.

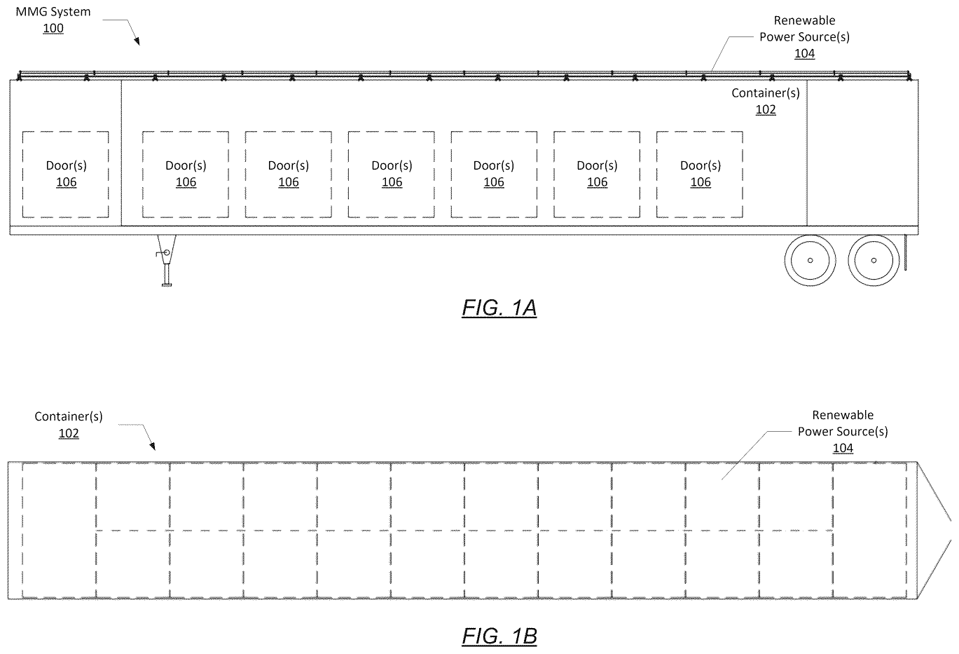

FIGS. 1A and 1B illustrate aspects of a mobile micro-grid (MMG) system (100) for supporting unmanned aerial vehicle (UAV) operations, including UAV deployment, charging, and control, using a transportable containerized infrastructure. The system (100) is structured to integrate energy generation, UAV docking, and control hardware in a mobile form factor.

In FIG. 1A, a side elevation view of MMG system (100) is shown. The MMG system includes a containerized housing (102). As used herein, a “containerized housing” refers to any enclosed transportable structure such as an ISO-standard intermodal shipping container (e.g., 20-foot, 40-foot, or 53-foot lengths) configured to house electrical, mechanical, and UAV systems. The containerized housing (102) may be coupled to a trailer chassis or vehicle mount to enable transportation to and from deployment sites.

Mounted on an upper surface of containerized housing (102) are renewable power source(s) (104). As used herein, “renewable power source(s)” refers to any onboard renewable energy generation elements such as photovoltaic modules, solar thermal collectors, wind turbines, or hybrid combinations thereof. In the present embodiment, renewable power source(s) (104) comprise a solar panel array fixed across the roof of the containerized housing. These renewable power source(s) (104) are electrically coupled to internal power management circuitry, including energy storage and power conversion equipment, as further detailed in subsequent figures.

Distributed along the sidewall of containerized housing (102) are a plurality of door(s) (106). A “door” refers to any panel mounted to a wall or frame of the containerized housing that is operable between a closed (stored) position and an open (deployed) position. In some embodiments, each door (106) is hinged along a lower edge to rotate outward and downward from the container to form a generally horizontal surface. In this deployed position, door(s) (106) serve as UAV takeoff and landing platforms and may integrate electrical and communication components. Each door (106) may include an embedded inductive charging pad to wirelessly transfer energy to a UAV positioned on the platform.

Each door (106) is associated with at least one UAV docking station located either on the interior side of the door or within the container volume aligned with the door opening. A “UAV docking station” refers to any physical or electromechanical interface configured to support UAV storage, alignment, charging, and launch or recovery functions. In some embodiments, each UAV docking station includes guide structures, power couplings (wired or wireless), and sensors to monitor UAV status.

The containerized housing (102) includes sufficient structural openings and access points corresponding to the number and spacing of door(s) (106) to enable direct egress for UAVs. In this example, the layout includes eight door(s) (106) arranged along the side of the container, each spaced laterally and aligned with internal UAV storage compartments and docking positions.

FIG. 1B shows a top plan view of the MMG system (100), illustrating the relative position of the renewable power source(s) (104) mounted to the top surface of containerized housing (102). The solar panel array (104) spans the full roof area, maximizing incident solar exposure for electrical generation. The plan view further reveals the lateral distribution of the underlying door(s) (106), as shown by dashed lines.

In operation, the MMG system (100) is deployed to a field location where the containerized housing (102) is positioned for operation. Renewable power source(s) (104) generate power to charge an onboard energy storage system. UAVs are stored and maintained within the container, and are selectively deployed by actuating one or more door(s) (106) to the deployed position. UAVs can land on the deployed doors and engage in charging via docking stations integrated therein. A control system within the container manages the deployment, charging schedule, telemetry, and flight coordination of the UAVs.

This configuration supports the claims by establishing a transportable containerized housing incorporating renewable power source(s), deployable UAV launch and landing door(s), UAV docking stations configured for power transfer, and control elements for autonomous UAV operation. The figures illustrate a system architecture with distributed UAV access points, renewable energy capture, and modular deployment capability.

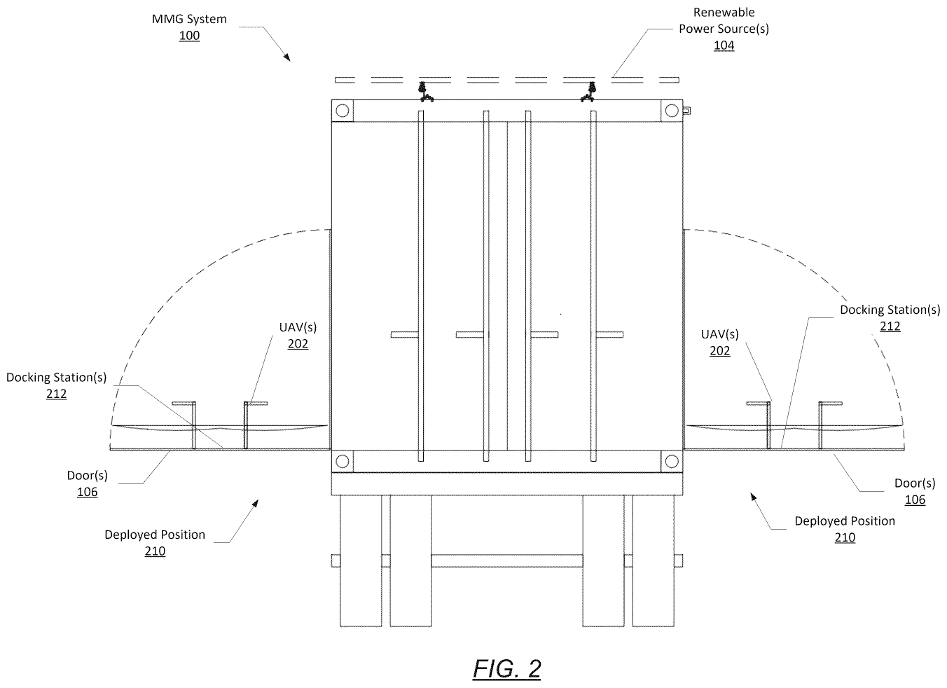

FIG. 2 shows a front elevation view of a mobile micro-grid (MMG) system (100) in a deployed configuration, including unmanned aerial vehicle (UAV) docking features for autonomous launch and recovery. The illustration highlights the relationship between the containerized structure, power systems, UAVs, and associated deployment platforms.

The MMG system (100) includes a containerized housing as previously described. Mounted on the top surface of the containerized housing are renewable power source(s) (104). The renewable power source(s) (104) may include one or more photovoltaic modules arranged in a planar array across the roof of the container to provide onboard energy harvesting capability. These modules are electrically connected to an energy storage system housed within the container.

Positioned along the lower lateral sides of the container are door(s) (106). Each door (106) is shown in a deployed position (210). As used herein, “deployed position” refers to an orientation in which the door has been actuated from a stored vertical position to a generally horizontal position extending outward from the container. Each door (106) is mechanically hinged and may be operated by an electronic actuator coupled to the container frame. In the deployed position (210), door(s) (106) define platforms suitable for supporting UAV takeoff and landing.

A plurality of UAV(s) (202) are shown staged on the deployed door(s) (106). Each UAV (202) refers to an aerial vehicle operable without an onboard human pilot and may include a propulsion system, navigation system, and onboard electronics for communication and flight control. The UAV(s) (202) are aligned with associated docking station(s) (212) located on the surface of the deployed door(s) (106). As used herein, a “docking station” refers to any structure configured to facilitate UAV alignment, energy transfer, and status monitoring during non-flight intervals.

Each docking station (212) may include an inductive charging pad, guide rails, landing registration features, and sensors for battery state or alignment detection. In some embodiments, docking stations (212) communicate bidirectionally with a control system within the MMG system (100) to initiate or terminate charging operations based on energy availability and UAV schedule data. The control system may further issue flight readiness commands or confirm UAV status prior to deployment.

The deployed door(s) (106) and associated docking station(s) (212) establish the UAV launch and recovery interface of the MMG system. Each docking station (212) is mapped to a corresponding internal UAV storage bay and control unit. The front-facing layout shown in FIG. 2 demonstrates a dual-side deployment configuration, with door(s) (106) and docking station(s) (212) located symmetrically on opposing sides of the containerized housing. This layout allows multiple UAVs (202) to be simultaneously launched, landed, or charged in parallel.

The arrangement illustrated in FIG. 2 supports the claims by depicting the operative relationship between containerized housing, renewable power subsystem, deployable door-based platforms, and UAV docking stations. The drawing emphasizes autonomous charging and UAV deployment functionality integrated into a mobile, containerized energy infrastructure.

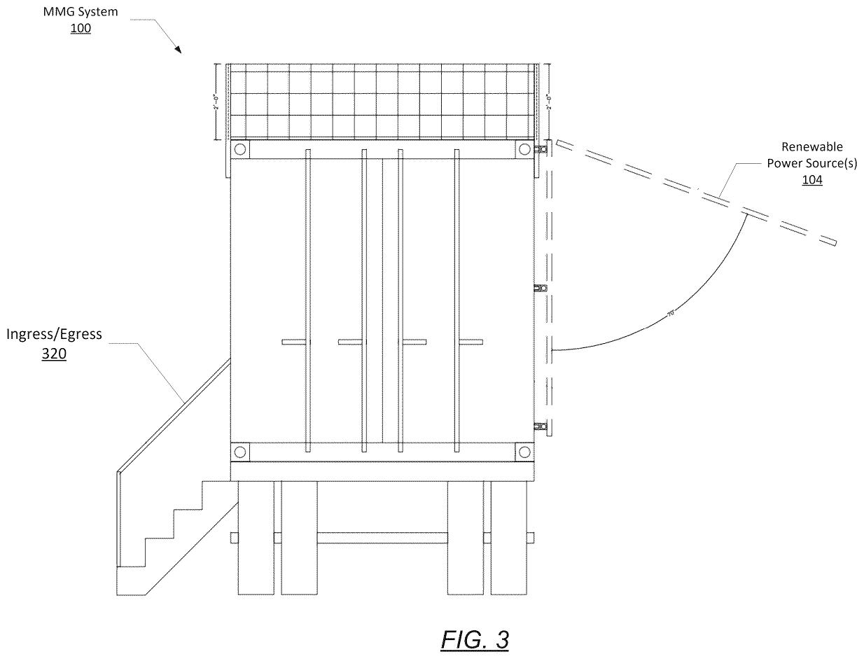

FIG. 3 illustrates a mobile micro-grid (MMG) system (100) incorporating an alternative embodiment of the renewable power source(s) (104), configured for rotational deployment along a lateral side of the containerized housing. This embodiment supports flexible energy capture by enabling reorientation of renewable power elements relative to sun position or container orientation.

The MMG system (100) comprises a containerized housing mounted on a transportable chassis. As previously defined, the containerized housing provides a structure for enclosing operational components including UAV systems, control electronics, and energy management equipment. The structure shown in FIG. 3 includes a stair-based ingress/egress (320) allowing personnel access to internal systems for service or configuration.

Renewable power source(s) (104) are mounted to an upper portion of the container but are shown in a pivotable configuration. As used herein, “renewable power source(s)” refers to energy harvesting modules such as solar panels or wind energy converters. In this embodiment, the renewable power source(s) (104) comprise one or more solar panel arrays mounted to pivot arms or brackets that allow rotation from a stowed vertical orientation (e.g., during transport or storage) to a deployed angled position.

The arc path indicated in FIG. 3 reflects the rotational range of motion of the renewable power source(s) (104). A mechanical hinge or pivoting joint permits the renewable power source(s) (104) to rotate outwardly from the side of the container. In some embodiments, the pivot mechanism is motorized and operable by the onboard control system, allowing for automated solar tracking or positional optimization based on environmental conditions. The rotation mechanism may further be lockable in a deployed angle to maximize incident sunlight or comply with wind load requirements.

The ingress/egress (320) includes a set of stairs and handrails extending from ground level to the container threshold. This structure provides physical access for operators or maintenance personnel to enter the MMG system (100) for inspection, diagnostics, or manual overrides. In some implementations, ingress/egress (320) may include a security system, electronic access control, or removable modular structure.

The system as shown supports the claims by providing a containerized housing with integrated renewable power source(s), wherein the renewable power source(s) are mounted to allow positional adjustment. This differs from fixed-roof-mounted configurations shown in FIGS. 1 and 2 and may support increased deployment flexibility in uneven terrain, urban environments, or high-latitude locations. This embodiment remains consistent with the mobile and autonomous functionality of the MMG system by incorporating onboard mechanisms for energy system configuration.

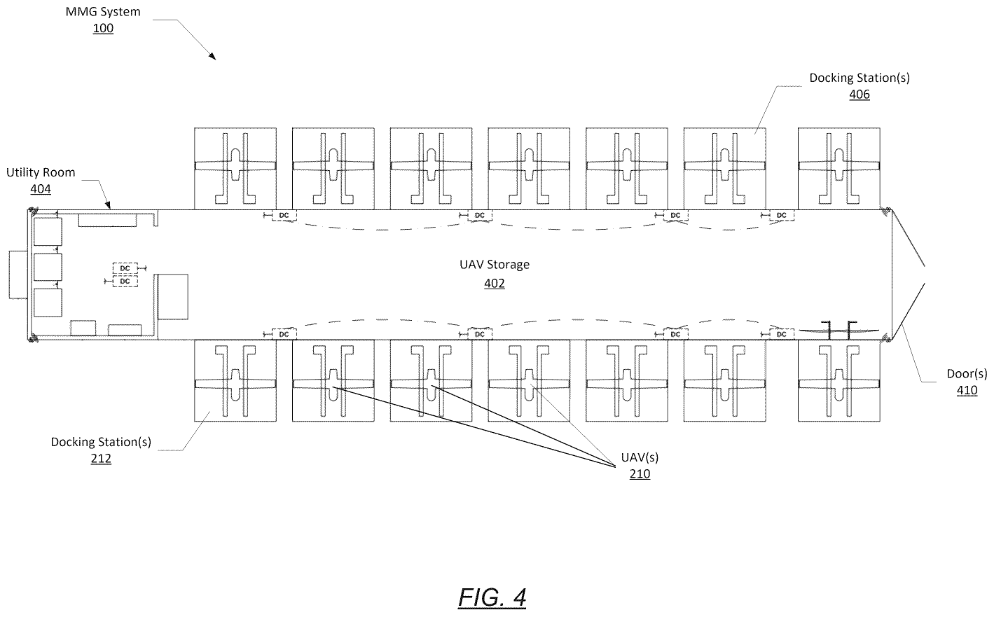

FIG. 4 illustrates a top plan view of a mobile micro-grid (MMG) system (100) including internal spatial organization and the positioning of UAV-related subsystems. The MMG system is arranged within a containerized housing, as previously defined, which houses structural and electrical components for energy storage, control, UAV docking, and deployment.

A centrally located UAV storage (402) spans a major lengthwise portion of the container. As used herein, “UAV storage” refers to an internal compartment configured to house one or more unmanned aerial vehicles (UAVs) (210) when not in flight. UAVs (210) are shown in stowed positions within the storage (402) region, each oriented for access to corresponding docking and deployment components. UAV (210) refers to a remotely or autonomously operated aerial vehicle, and may include multirotor or fixed-wing variants, equipped with energy storage and onboard navigation systems.

Positioned along opposing sidewalls of the container are docking station(s) (212) and docking station(s) (406). Each docking station (212) or (406) includes features to mechanically and electrically interface with UAVs for landing, charging, and alignment. Docking station(s) may include wireless charging pads (e.g., inductive coils), mechanical alignment structures, sensors for battery monitoring, and communications interfaces. The placement of docking station(s) adjacent to UAV storage (402) enables 1:1 association between stowed UAVs and their launch/recovery ports.

Doors (410) are positioned adjacent to the docking station(s), and are configured to operate between a closed position and a deployed position. In the deployed position, each door (410) rotates downward and outward to form a horizontal UAV launch and landing platform. Door (410) may be actuated via hydraulic or electromechanical mechanisms and may serve as structural bases for embedded charging coils or surface-mounted docking features.

A utility room (404) is located at one end of the container and is enclosed within a designated portion of the housing. As used herein, “utility room” refers to an internal compartment that contains electrical infrastructure including inverters, load panels, backup generators, cooling systems, and control processors. In this embodiment, the utility room (404) includes at least one direct current (DC) power management node for interfacing with the renewable power subsystem and distributing energy to the various UAV docking station(s) and other container subsystems.

The DC bus architecture is schematically shown connecting utility room (404) to distributed docking station(s) (212) and (406). These interconnections support power transfer to charging circuits, enabling energy storage devices within the UAVs to be replenished wirelessly or via conductive means. The distributed layout enables parallel charging of multiple UAVs across both sides of the container.

The arrangement illustrated in FIG. 4 supports the claims by disclosing a system comprising a containerized housing, onboard UAV storage, deployable doors associated with UAV docking stations, an energy management system integrated in a utility room, and routing of energy via DC infrastructure. This configuration enables autonomous storage, charging, and deployment of UAVs from a mobile, renewable-powered system.

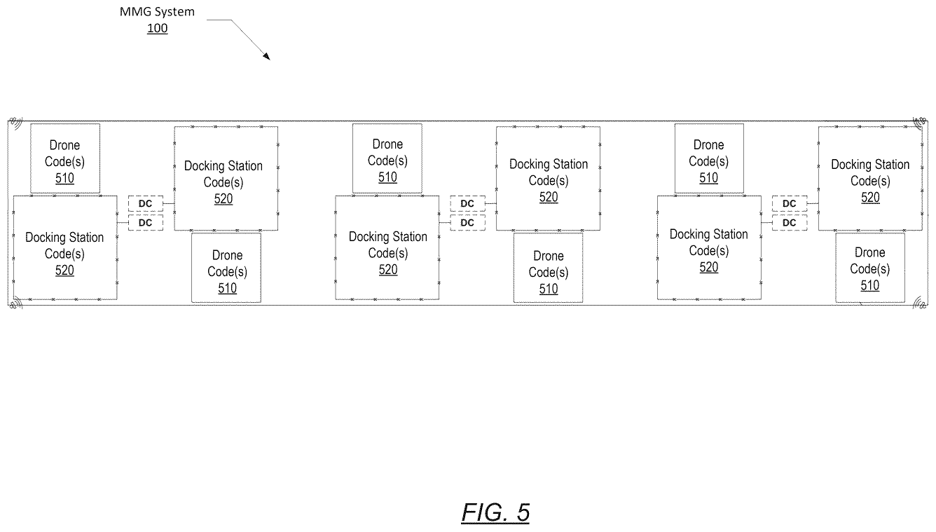

FIG. 5 illustrates an assignment system for unmanned aerial vehicle (UAV) docking within a mobile micro-grid (MMG) system (100). The figure depicts the association of UAV identifiers with corresponding docking stations through use of embedded identification technologies.

A plurality of drone code(s) (510) are shown associated with discrete UAV locations within the MMG system. As used herein, “drone code” refers to any machine-readable or electronically detectable identification marker uniquely associated with a UAV. Examples include printed quick response (QR) codes, RFID tags, near-field communication (NFC) markers, or machine vision fiducials. These drone codes (510) may be affixed to physical UAVs, encoded into flight software, or stored in memory accessible to the system control processor.

Positioned adjacent to each drone code (510) is a corresponding docking station code (520). A “docking station code” is an identification feature that uniquely designates a UAV docking location within the MMG system. Docking station codes (520) may also utilize QR, RFID, NFC, or optical encoding methods and are positioned to be read by onboard sensors or external readers. Each code (520) is paired with a physical docking station location, such as an inductive charging pad or mechanical UAV alignment fixture.

Drone code(s) (510) and docking station code(s) (520) may be physically co-located, or may be separated with machine vision, magnetic, or RF correlation mechanisms implemented to determine their functional pairing. In some embodiments, a UAV reads its own drone code (510) and the nearby station code (520), transmitting both to a control system to validate assignment. In other embodiments, the MMG control processor maintains a mapping database between UAV IDs and dock locations based on code pairings.

The figure also shows distributed DC bus links interconnecting the docking station areas. These lines supply electrical power from the MMG system's internal power management infrastructure to each docking station. As previously defined, the DC distribution system is coupled to the renewable power sources and energy storage subsystems and supports direct power delivery to UAV charging pads embedded in the docking stations.

The illustrated method of code-based assignment enables programmatic pairing of UAVs with designated docking stations, facilitating coordinated charging, maintenance, and launch sequencing. Code pairings may also be used for access control, flight scheduling, system diagnostics, or to implement mission-specific UAV assignments.

This configuration supports the claims by enabling automated UAV-to-dock assignment using coded identifiers within a containerized, energy-autonomous deployment system. The pairing system improves UAV deployment coordination and operational traceability.

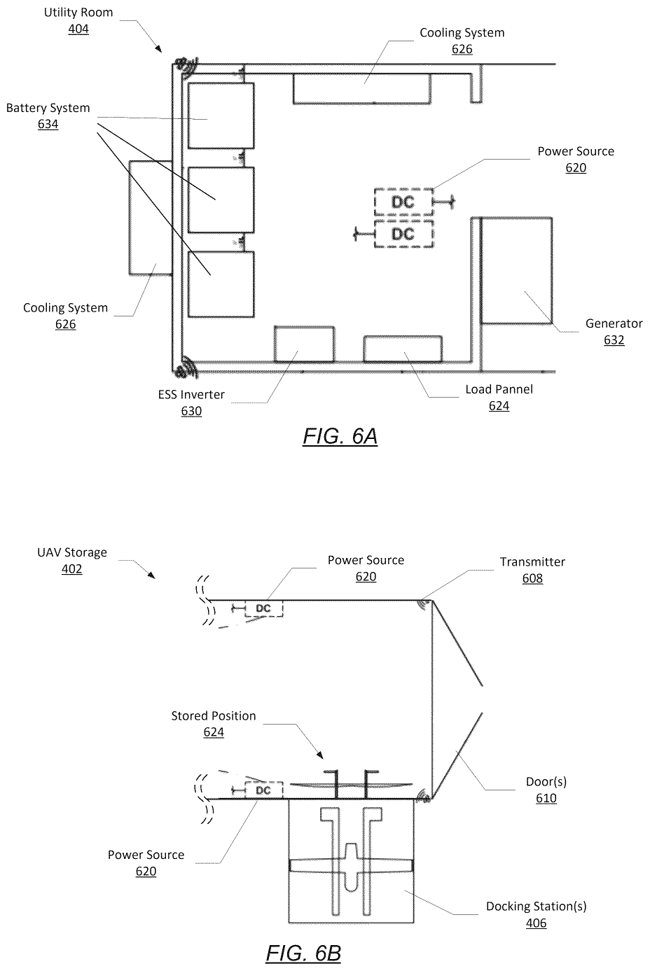

FIGS. 6A and 6B illustrate portions of the mobile micro-grid (MMG) system (100), showing an internal layout of the utility room and representative deployment architecture for a UAV docking interface.

FIG. 6A shows a top plan view of the utility room (404), positioned within a rear portion of the containerized housing. As used herein, the “utility room” is an enclosed sub-compartment that houses system control, power management, and cooling components. Positioned within the utility room (404) is a power source (620). The term “power source” broadly refers to one or more electrical generation and/or storage devices providing energy to support UAV charging and system operation. In some implementations, the power source (620) includes a battery system (634).

The battery system (634) is shown as a bank of energy storage modules electrically connected in a DC configuration. Each module in the battery system (634) may comprise lithium-ion, solid-state, or other electrochemical storage technologies capable of delivering the sustained DC output required to operate UAV docking station loads and auxiliary infrastructure.

Adjacent to the battery system (634) is a cooling system (626). The cooling system (626) includes components such as air conditioning units, fans, or liquid cooling circuits. These regulate the thermal environment inside the utility room to ensure proper operating conditions for the battery system (634), inverter electronics, and other sensitive control equipment.

Also disposed within the utility room (404) is an ESS inverter (630). The “ESS inverter” converts direct current (DC) from the battery system into alternating current (AC) for use by auxiliary subsystems. In some embodiments, the inverter (630) is bi-directional and supports grid interconnection functionality or dynamic energy routing. The inverter is electrically coupled to a load panel (624). The load panel (624) acts as the system's electrical distribution node, routing power from the inverter and battery system to the UAV docking station network, communications equipment, and cooling system.

A generator (632) is located at one end of the utility room. The generator (632) serves as a supplemental power source and may be automatically engaged during high-demand periods or when the battery system (634) is depleted. The generator may be a diesel, propane, or hybrid-type generator with automatic start functionality and integration into the MMG control system.

In some embodiments, the generator (632) within the utility room (404) may comprise a hydrogen generator configured to produce hydrogen gas through an electrolysis process or other hydrogen generation method. The hydrogen generator may include an integrated electrolyzer that separates hydrogen from water using electrical energy supplied by the renewable energy subsystem or the onboard battery system (634). This configuration enables on-site generation of hydrogen fuel without requiring pre-filled hydrogen tanks or offsite hydrogen delivery, facilitating autonomous system operation in remote or undeveloped areas.

The generated hydrogen gas may be stored in one or more onboard storage tanks and routed via a distribution manifold to refueling ports associated with designated hydrogen-powered UAVs. Each refueling port may be integrated with a corresponding UAV docking station (406) and equipped with safety interlocks, flow regulators, and sensors for pressure, temperature, and fill-level monitoring. The control system of the MMG system (100) may monitor hydrogen production and storage levels, schedule hydrogen refueling cycles based on UAV mission parameters, and coordinate power allocation between electrolysis operations and other system loads. This implementation supports deployment of fuel cell-powered UAVs and enables extended flight duration beyond the limitations of battery-based propulsion systems.

FIG. 6B shows a sectional view of a UAV storage and deployment area, including door(s) (610) and docking station(s) (406). A door (610) is shown in a deployed configuration extending from the containerized housing. In the stored position (624), the door is vertically aligned with the housing sidewall. The transition between stored and deployed positions may be actuated by an electromechanical actuator integrated into the container frame. When deployed, door (610) forms a flat UAV landing and takeoff surface.

Docking station(s) (406) are aligned with the deployed door (610) and are configured for power transfer and physical support of a UAV during charging. Each docking station (406) includes mechanical and electrical interfaces for UAV registration and energy transfer. Power source (620) is shown routing energy from the utility room to the docking stations.

A transmitter (608) is mounted near the UAV docking interface. The transmitter (608) refers to a wireless communication unit used to maintain contact with one or more UAVs during flight operations. The transmitter may support RF, LTE, LoRa, or satellite links for telemetry, control, and status monitoring.

The layout illustrated in FIGS. 6A and 6B supports the claims by providing examples of a modular containerized power distribution architecture, a deployable UAV interface with onboard charging, and autonomous flight management supported by wireless communication and dynamic power routing. Each of these element's functions within the mobile, container-integrated MMG system to provide unmanned aerial vehicle support at remote or off-grid locations.

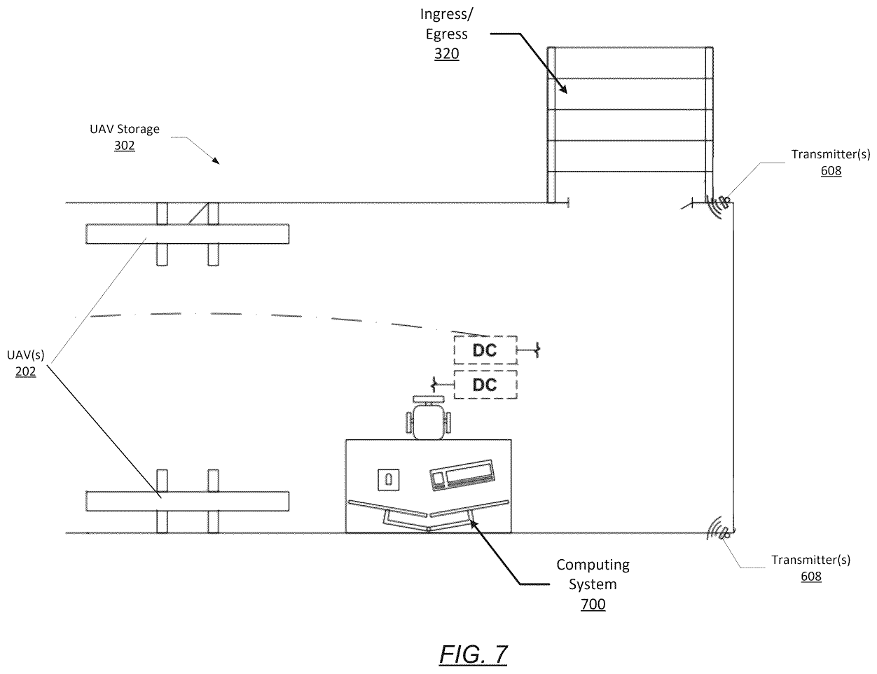

FIG. 7 illustrates an embodiment of a computing system (700) integrated within the mobile micro-grid (MMG) system (100). The computing system (700) is located in an interior space of the containerized housing and is positioned between the UAV storage area (302) and the ingress/egress structure (320). The computing system provides centralized control, monitoring, and data processing functionality for all onboard operations, including UAV coordination, energy management, and communication.

UAV storage (302) is located along one side of the container and includes a plurality of UAVs (202) arranged in a stowed configuration. UAV (202) refers to an unmanned aerial vehicle capable of autonomous or semi-autonomous operation, and may include vertical takeoff and landing (VTOL) or fixed-wing designs. Each UAV is stored in a defined compartment that provides physical support and may also include connections to onboard charging or maintenance subsystems.

The computing system (700) may include a processor, memory, input/output interfaces, and non-transitory machine-readable storage. The system executes software modules responsible for scheduling UAV missions, receiving telemetry data, allocating charging resources, and interfacing with other system components. In some embodiments, the computing system (700) includes graphical user interface hardware (e.g., display monitor, keyboard, and pointer device) for local human interaction. Alternatively, or additionally, remote access may be supported over wireless or satellite data links.

Transmitters (608) are shown positioned at two corners of the containerized housing. As used herein, transmitter (608) refers to a communications device configured to exchange data between the MMG system and UAVs (202) or external systems. Each transmitter may support protocols including Wi-Fi, LTE, LoRaWAN, or satellite uplink depending on mission requirements. These devices allow for continuous telemetry, mission update commands, health monitoring, and remote control. In some embodiments, the transmitters also support secure communication using encryption standards.

Ingress/egress (320) is a stairway structure positioned adjacent to the computing system (700) and provides access for personnel to enter or exit the container. The physical location of the ingress/egress and the computing system facilitates convenient manual access to system controls and status indicators.

A DC power bus is routed near the computing system (700) and supplies electrical energy from the onboard power source to computing and communication equipment. This DC supply may be regulated by power distribution hardware and protected using surge protection and isolation devices. The configuration shown in FIG. 7 supports integration of autonomous control and communication within the MMG container, aligned with claim elements directed to system control, UAV deployment coordination, and remote operability.

The computing system (700) integrated within the mobile micro-grid (MMG) system (100) serves as the centralized control platform for managing UAV deployment, energy usage, communications, and system coordination. The computing system executes control software stored in memory and operated by an onboard processor. The software system interfaces with sensors, docking stations, power subsystems, and external communication links to monitor conditions and coordinate UAV operations. Each core function corresponds to one or more control routines, executed autonomously or in response to user-initiated commands.

The computing system monitors the state of charge (SOC) for the onboard battery system and energy input from the renewable power sources. Using this data, the system prioritizes UAVs for charging based on urgency of mission schedule, remaining battery capacity, and projected power inflow. A charging queue is dynamically generated and updated using an internal scheduler, which may weight UAV criticality or projected mission duration. The control system can delay or throttle individual UAV charging cycles to maintain minimum reserves for essential system functions.

Power distribution commands are communicated to each UAV docking station over a local control bus or wireless communication protocol. These commands may enable, disable, or pulse energy to each docking station's charging interface. The system continuously evaluates energy conditions, adjusting charging parameters based on updated solar availability, load demands, or battery bank limitations.

The computing system maintains deployment routines that actuate the door mechanisms and initiate UAV launch sequences. Each UAV's assigned door and associated docking station are tracked by the system using unique identifiers, which may correspond to docking station codes or drone codes described in FIG. 5. Upon launch authorization, the system verifies door position sensors, actuates the door to the deployed position, and sends activation signals to the UAVs via local RF or other communication links.

Safety interlocks may be enforced through logic routines that inhibit launch if system telemetry indicates mechanical obstruction, low system voltage, or active refueling or charging operations. Once clearance is confirmed, the computing system transmits a launch command to the UAV's onboard controller. Following takeoff, the door may be returned to its stored position under automated control, or remain deployed depending on upcoming landings.

The computing system continuously manages wireless communications with UAVs using the onboard transmitter(s) (608). These transmitters support real-time telemetry links for position, velocity, battery level, and fault conditions. Communication parameters are defined by a data link manager running on the computing system, which establishes and maintains network association with each UAV in flight or docked.

During takeoff and landing, the system monitors UAV status flags, and positional beacons to ensure successful transitions. If a loss of signal or unexpected delay occurs, fallback routines may be executed, including retry commands, UAV hovering logic, or alert generation. Communications during charging are used to report charge rate, temperature, and cell balance conditions. These are displayed to users via the local or remote user interface.

The control software includes an energy allocation module that evaluates energy supply and demand in real-time. This module receives telemetry from the battery system, generator, and renewable sources, and compares that against predicted load from the computing system, cooling systems, lighting, and UAV charging needs. Based on mission requirements received from flight planning modules, the system prioritizes energy delivery accordingly.

For example, if multiple UAVs are scheduled for launch within a brief period, the control system may suspend or reduce power to non-critical loads such as lighting or air conditioning to preserve battery reserves. Conversely, during idle periods, stored energy may be diverted to maintenance charging or system diagnostics. Allocation decisions are logged and optionally sent to remote monitoring interfaces for auditing.

The computing system (700) includes a software module that exposes system status and control functions via a graphical user interface (GUI). This interface may be hosted locally on an embedded touchscreen display or remotely accessed over secure IP links using wireless transceivers. Remote users can view UAV deployment schedules, charging states, fault logs, and available energy reserves in real-time.

Commands issued from the interface are processed through an access control system and routed to corresponding subsystems through the onboard control network. Example commands include launching UAVs, updating flight schedules, initiating maintenance cycles, or modifying energy thresholds. Secure authentication is required for control commands, and all actions are logged for system accountability.

A flight schedule processor module parses incoming data packets containing scheduled missions, including launch time, payload type, and destination. The computing system correlates these missions with onboard UAV availability and current energy conditions. Flight schedules may be uploaded from a remote server, entered manually through the interface, or generated by an automated mission planner.

Energy availability data is retrieved from the battery management system (BMS), solar charge controller, and generator controller. The control system reconciles these two data streams—energy supply and demand—to create an executable UAV dispatch plan. This ensures mission readiness is validated against available energy reserves before authorizing UAV deployment.

The control system identifies which UAVs are positioned on inductive or resonant charging pads based on docking station identifiers and drone position sensors. Each UAV is assigned a power transfer priority based on flight schedule, energy status, and available system power. The charging controller transmits activation signals to the appropriate inductive pad control electronics, enabling energy transfer from the container's power bus to the UAV's onboard battery.

The control system monitors power draw, heat dissipation, and charge progress for each UAV. If system power limits are reached, the controller may reduce charging rates or implement sequential charging logic. Alerts are generated for anomalies such as power mismatch, thermal faults, or charge timeout events.

Each UAV's docking station and door location are logged in memory, enabling precise coordination of deployment. The computing system checks deployment readiness including door status, UAV battery level, and airspace clearance. Once ready, the software initiates deployment sequences for one or more UAVs simultaneously or in staggered intervals.

Deployment commands may include preflight checks, unlocking docking restraints, transmitting mission coordinates, and confirming communication link status. The system verifies successful liftoff via local sensors or UAV telemetry and transitions to post-launch monitoring mode.

While in flight, each UAV periodically transmits status data to the MMG system's computing system. This includes GPS position, altitude, heading, battery voltage, current draw, estimated time to depletion, and any fault codes. Data is stored in real-time and visualized through the user interface for operator review.

Alerts or exceptions trigger preconfigured system responses, such as initiating return-to-base commands, issuing ground-based notifications, or invoking a failsafe protocol. Logged telemetry may be archived for post-mission analysis or integration with third-party systems.

An alert management module runs periodic energy budget analyses, simulating future UAV demands against projected energy inflow and current battery reserves. If a predicted shortfall is detected—such as insufficient energy to charge the next set of scheduled UAVs or complete a critical mission—alerts are generated and transmitted to the user interface.

Alerts may include recommendations for system behavior, such as canceling nonessential loads, delaying UAV deployment, or triggering the generator to increase supply. Alerts are timestamped, categorized by severity, and include suggested remediation steps. The system may also log corrective action acknowledgments from human operators or autonomous overrides.

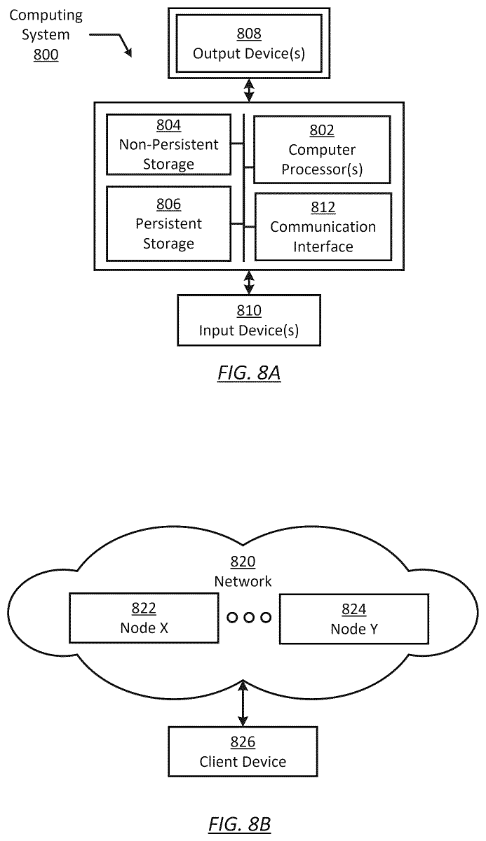

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 8A, the computing system (800) may include one or more computer processors (802), non-persistent storage (804), persistent storage (806), a communication interface (812) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) may be one or more cores or micro-cores of a processor. The computer processor(s) (802) includes one or more processors. The one or more processors may include a central processing unit (CPU), a graphics processing unit (GPU), a tensor processing units (TPU), combinations thereof, etc.

The input devices (810) may include a touchscreen, keyboard, mouse, microphone, touchpad, electronic pen, or any other type of input device. The input devices (810) may receive inputs from a user that are responsive to data and messages presented by the output devices (808). The inputs may include text input, audio input, video input, etc., which may be processed and transmitted by the computing system (800) in accordance with the disclosure. The communication interface (812) may include an integrated circuit for connecting the computing system (800) to a network (not shown) (e.g., a local area network (LAN), a wide area network (WAN) such as the Internet, mobile network, or any other type of network) and/or to another device, such as another computing device.

Further, the output devices (808) may include a display device, a printer, external storage, or any other output device. One or more of the output devices may be the same or different from the input device(s). The input and output device(s) may be locally or remotely connected to the computer processor(s) (802). Many diverse types of computing systems exist, and the aforementioned input and output device(s) may take other forms. The output devices (808) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (800) in FIG. 8A may be connected to or be a part of a network. For example, as shown in FIG. 8B, the network (820) may include multiple nodes (e.g., node X (822), node Y (824)). Each node may correspond to a computing system, such as the computing system shown in FIG. 8A, or a group of nodes combined may correspond to the computing system shown in FIG. 8A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822), node Y (824)) in the network (820) may be configured to provide services for a client device (826), including receiving requests and transmitting responses to the client device (826). For example, the nodes may be part of a cloud computing system. The client device (826) may be a computing system, such as the computing system shown in FIG. 8A. Further, the client device (826) may include and/or perform all or a portion of one or more embodiments of the invention.

The computing system of FIG. 8A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such includes the term “and.” Further, items joined by the term “or” may include any combination of the items with any number of each item unless, expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A mobile micro-grid system for supporting unmanned aerial vehicle (UAV) operations, the system comprising:
a containerized housing;
at least one door mounted to a side of the containerized housing, the door operably deployable between a stored position and a deployed position;
at least one UAV docking station associated with the at least one door, each docking station configured for power transfer to a corresponding UAV;
a renewable energy subsystem integrated into the containerized housing, the renewable energy subsystem comprising one or more renewable power sources on an exterior surface of the container;
an onboard energy storage system electrically coupled to the renewable energy subsystem and the UAV docking stations; and
a control system disposed within the containerized housing, the control system comprising a processor and memory storing instructions executable to autonomously:
manage charging schedules for the UAVs based on power availability;
deploy UAVs from the deployed door; and
maintain communications with the UAVs during landing, takeoff, and charging operations.

2. The mobile micro-grid system of claim 1, wherein each UAV docking station includes an inductive charging pad embedded within the deployable door.

3. The system of claim 1, further comprising a utility room within the containerized housing, the utility room comprising:
a load panel,
an energy storage system (ESS) inverter,
a cooling subsystem, and
a backup generator.

4. The system of claim 3, wherein the ESS inverter is configured to convert DC power from the renewable energy subsystem to AC power for auxiliary loads.

5. The system of claim 1, wherein the control system includes a wireless transceiver configured to send flight instructions and receive telemetry from the UAVs.

6. The system of claim 1, wherein the deployable door comprises an electronic actuation mechanism and is configured to operate between horizontal and vertical positions without manual intervention.

7. The system of claim 1, wherein the UAV docking stations are arranged in a 1:1 correspondence with UAV storage compartments located inside the containerized housing.

8. The system of claim 1, further comprising an onboard software module configured to dynamically allocate available stored energy between charging operations and auxiliary systems based on UAV mission requirements.

9. The system of claim 1, wherein the containerized housing is a 20-foot, 40-foot, or 53-foot ISO-standard intermodal container.

10. The system of claim 1, further comprising a user interface accessible over a wireless communication link for remote system monitoring and command issuance.

11. A method for autonomously managing unmanned aerial vehicles (UAVs) using a mobile micro-grid system, the method comprising:
providing a containerized micro-grid system comprising:
a deployable landing platform;
a renewable energy subsystem;
power storage system; and
a wireless charging system;
receiving flight schedule data and energy availability data at a control system within the containerized system;
wirelessly charging a plurality of UAVs based on the received energy availability data;
autonomously deploying one or more UAVs from the deployable landing platform; and
monitoring the flight status and battery condition of the deployed UAVs via a communications link.

12. The method of claim 11, further comprising the step of adjusting the UAV charging priority based on mission criticality and remaining battery levels.

13. The method of claim 11, wherein deploying the UAVs comprises actuating a hinged container door from a vertical to a horizontal position using an electronic actuator.

14. The method of claim 11, further comprising the step of powering the wireless charging system using solar-generated electricity stored in the energy storage system.

15. The method of claim 11, further comprising the step of generating UAV flight logs and transmitting the logs to a control center.

16. A mobile UAV charging and deployment system, comprising:
a transportable container having a fold-out door configured as a UAV landing and takeoff pad;
a plurality of UAV docking bays located within the container;
an energy subsystem comprising:
a solar panel array mounted on the container;
a battery bank; and
an energy storage inverter;
a generator configured to supply backup power to the battery bank; and
a flight control subsystem comprising:
a UAV tracking interface;
a charge management processor; and
a software module executable to coordinate UAV launch timing with available energy capacity.

17. The system of claim 16, wherein the fold-out door is operatively coupled to a motorized actuator for automated deployment.

18. The system of claim 16, wherein the UAV docking bays are environmentally sealed and include thermal insulation and vibration dampening features.

19. The system of claim 16, wherein the software module is configured to generate alerts for anticipated power shortages affecting UAV mission readiness.

20. The system of claim 16, further comprising an onboard cooling unit configured to regulate temperature within an internal utility room.
